(19) United States
(12) Patent Application Publication
(10) Pub. No.: US 2005/0015440 A1
(43) Pub. Date: Jan. 20, 2005

(54) System and method for broadcasting content according to a preferred reception mode

(76) Inventor: Edwin Lee Solot JR., Los Angeles, CA (US)

Correspondence Address: FOLEY & LARDNER, 2029 CENTURY PARK EAST, SUITE 3500, LOS ANGELES, CA, 90067, US

(21) Appl. No.: 10/622,387

(22) Filed: Jul. 17, 2003

(51) Int. Cl. G06F 15/16

(52) U.S. Cl. 709/203

(57) ABSTRACT

A system and method by which an information broadcaster broadcasts content received from at least one information provider to a plurality of information receivers. A server device operated by the information broadcaster broadcasts the content over a network to client devices operated by information receivers. The content is transmitted to the client devices according to a preferred reception mode directly communicated from each of the client devices to the server device. The preferred reception mode indicates a preferred content reception device for converting the content to a user perceptible form. The preferred content reception device may be selected from a facsimile machine, a facsimile printer and a processing device such as a computer or personal digital assistant. The preferred reception mode may further indicate that a client device is in a non-reception mode, i.e., no content should be sent to the client device.

### BACKGROUND OF THE INVENTION

1. Field of the Invention

Embodiments of the present invention relate generally to broadcasting of information to multiple information receivers. More particularly, embodiments of the present invention relate to a system and method for broadcasting information to an information receiver according to a preferred reception mode that is directly communicated from the information receiver to an information broadcaster.

2. Description of the Related Art

In recent years, many information providers have begun to provide information to customers and others via facsimile (“fax”) machines, fax printers and electronic mail (“e-mail”). As an example, mortgage lenders such as wholesale mortgage companies and banking institutions may “fax” or e-mail mortgage rate information to retail mortgage brokers on an ongoing basis. As another example, a product wholesaler may provide product and pricing lists to product retailers. As yet a further example, a stock market analyst may provide a newsletter having stock recommendations to subscribers.

There are many difficulties associated with this method of providing information. For example, the information provided may change frequently. In the case of mortgage rates, for example, daily changes are possible. Thus, the information provider may be required to frequently update information by, for example, re-faxing it to information receivers.

In addition, the information provided may vary based on the particular geographic area or region where the information receiver is located. In that case, the information provider may be required to adjust the provided information based on its intended destination. Furthermore, the information provider may provide information to a large number (for example, thousands) of information receivers. This may require a large expenditure of money and time to acquire and maintain the necessary technology to support such large numbers of information receivers (for example, servers, software, modems, digital subscriber lines, etc.).

In order to avoid dealing with these difficulties themselves, many information providers have taken advantage of the services of information broadcasters. An information broadcaster may be, for example, a business that has the capacity (i.e., technology, manpower, etc.) to provide information to a large number of information receivers, for example, by fax and/or e-mail. The information broadcaster may accept a fee from information providers to provide information to large numbers of information receivers.

A block diagram of an exemplary relationship between an information provider 102, an information broadcaster 104 and an information receiver 106 is shown in FIG. 1. As shown in FIG. 1, the information provider 102 provides a listing of information receivers 106 (for example, a customer list) to the information broadcaster 104, along with the information (or “content”) to be provided to the information receivers 106. The information broadcaster 104 may then create or modify database files maintained by the information broadcaster 104 to include information included in the listing of information receivers 106, for example, a fax number, e-mail address, name, etc. The information broadcaster 104 then broadcasts the content (for example, by fax) to the information receivers 106 listed in the database. Database software employed by the information broadcaster 104 may maintain a correspondence between particular information receivers 106 and particular content to be communicated to the particular information receivers 106.

Conventionally, the information receiver 106 will communicate directly to an information provider 102 a preferred mode for receiving the content, also referred to in the present disclosure as a “preferred reception mode”. A preferred reception mode may, for example, designate a preferred device for receiving the content, also referred to in the present disclosure as a “preferred content reception device”.

FIGS. 2 and 3 show a block diagram and a flow diagram of a conventional system and method, respectively, for selecting a preferred reception mode. As shown, information receiver 106 selects a preferred reception mode and directly communicates the preferred reception mode selection to information provider 102 (S302). As stated above, the preferred reception mode may designate a preferred content reception device. As shown in FIG. 2, in the present example, the preferred content reception device may be selected from a fax machine 108 and a processing device 112 (for example, reception by an e-mail application running on processing device 112).

According to the conventional system and method of preferred reception mode selection shown in FIGS. 2 and 3, in addition to the content and the listing of information receivers, the information provider 102 must also communicate to information broadcaster 104 the preferred reception mode selected by information receiver 106 (S304). The information broadcaster 104 then delivers the content to listed information receivers 106 according to the selected preferred reception mode (S306).

Thus, according to the conventional system and method of preferred reception mode selection shown in FIGS. 2 and 3, if the information receiver 106 desires to change its preferred reception mode, the information receiver 106 will communicate this to the information provider 102. The information provider 102 will, in turn, have to provide information about the new preferred reception mode selection to the information broadcaster 104. The information broadcaster 104 may then update a database file corresponding to the particular information receiver 106 to include the new selection.

The conventional method of preferred reception mode selection described above may be a burden on information providers. For example, there may be a large number of information receivers and/or the information receivers may frequently change their preferred reception mode. In either case, the information providers must spend considerable time and resources in receiving the communicated preferred reception mode selections from the information receivers and in relaying this information to the information broadcasters. Additionally, information receivers must spend considerable time and resources communicating preferred reception mode selections to multiple information providers.

Therefore, there is a need for a system and method of selecting a preferred reception mode that reduces the burden on information providers and information receivers.

### SUMMARY OF THE DISCLOSURE

According to embodiments of the present invention, a system with at least one server device and a plurality of client devices communicating content to and from the at least one server device via a network is disclosed. The system comprises a processor programmed for receiving content from at least one of the plurality of client devices and transmitting the content to at least one other of the client devices according to a preferred reception mode. The preferred reception mode is directly communicated from the at least one other of the client devices to the at least one server device.

According to embodiments of the present invention, the preferred reception mode may comprise at least one of receiving the content by facsimile and receiving the content by electronic mail. When content is received by e-mail it may be automatically printed by a fax printer. The preferred reception mode may indicate a preferred content reception device for converting the content to a user perceptible form. The preferred reception mode may further indicate that the content should not be provided to a client device when a non-reception mode has been specified for the client device.

According to further embodiments of the present invention, a lockdown mode may be implemented for a client device wherein the preferred reception mode of the client device may only be altered after an information receiver verification process. The information receiver verification process may verify an Automatic Number Identification (ANI) of a communication device.

In one embodiment, the information receiver may fax or call an information broadcaster as part of the information receiver verification process. The information broadcaster may then detect the information receiver's ANI and compare it to a previously registered ANI, phone number and/or fax number corresponding to the information receiver and saved by the information broadcaster to determine if the information receiver is authentic.

According to further embodiments of the present invention, a billing method for an information broadcaster is disclosed. The billing method comprises broadcasting content to a plurality of client devices associated with a corresponding plurality of information receivers. The content is received from information providers and the information broadcaster charges a fee for broadcasting the content. The information broadcaster may provide a user interface accessible to the information receivers. The user interface enables an information receiver to specify that a client device associated with the information receiver be in a non-reception mode. When a client device is in a non-reception mode, the content is not broadcasted to the client device by the information broadcaster. The information provider is, in that case, only billed for content that was broadcast.

These and other features and advantages of embodiments of the invention will be apparent to those skilled in the art from the following detailed description of embodiments of the invention, when read with the drawings and appended claims.

### BRIEF DESCRIPTION OF THE DRAWINGS

Referring now to the drawings in which like reference numbers represent corresponding parts throughout:

FIG. 1 is a block diagram of an exemplary relationship between an information provider, an information broadcaster and an information receiver;

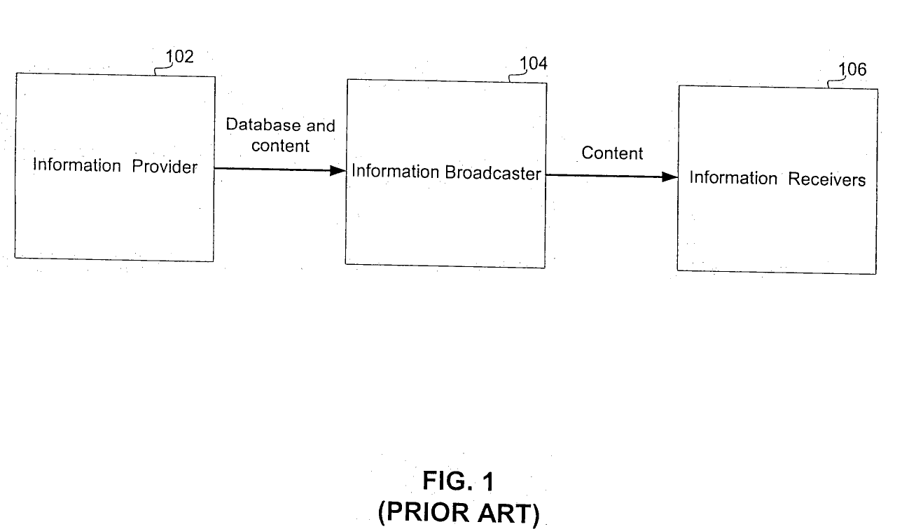

FIG. 2 is a block diagram of a conventional system for selecting a preferred mode for receiving content from an information broadcaster;

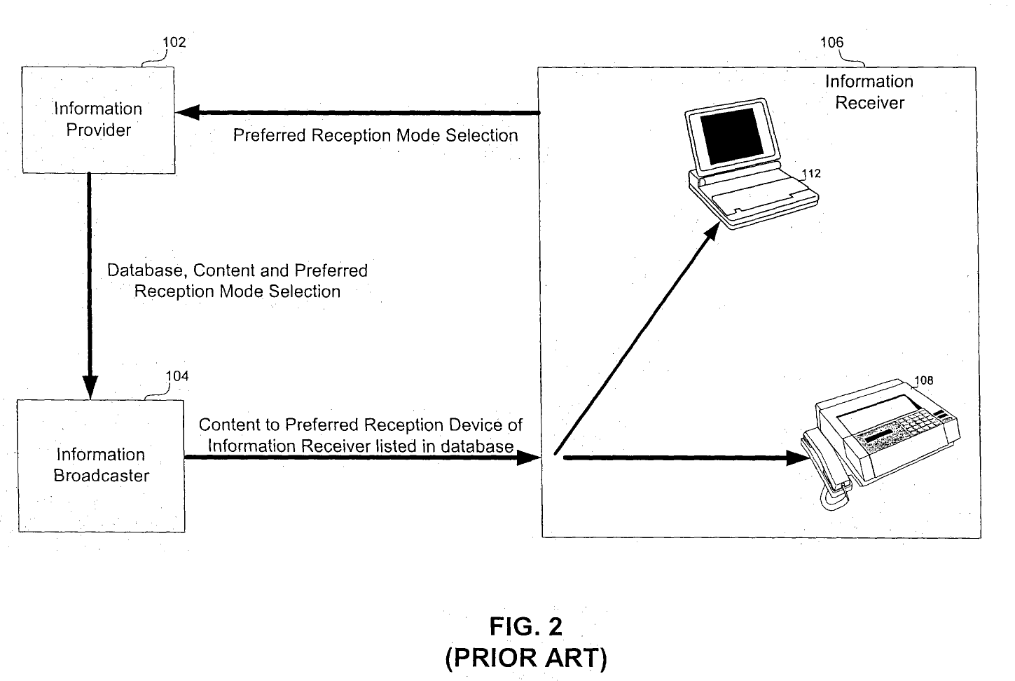

FIG. 3 is a flow diagram of a conventional method for selecting a preferred reception mode for receiving content from an information broadcaster;

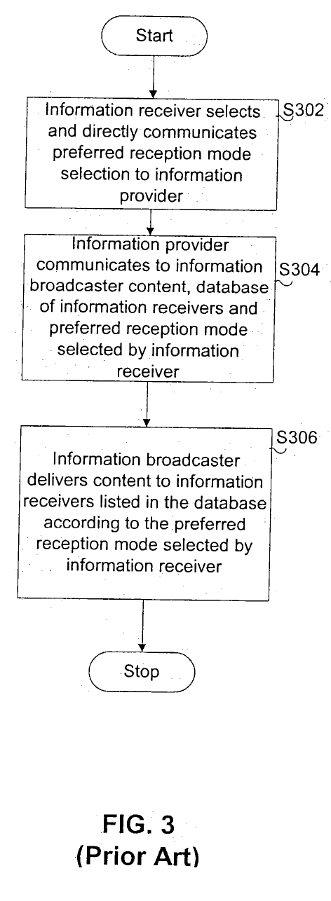

FIG. 4 is a block diagram of an exemplary client-server environment in which a system and process according to embodiments of the invention may be employed;

FIG. 5 illustrates an exemplary hardware/software environment wherein embodiments of the system and process of the present invention may be employed;

FIG. 6 shows an exemplary webpage for uploading content, according to embodiments of the present invention;

FIG. 7 shows an exemplary webpage for uploading a database file, according to embodiments of the present invention;

FIG. 8 is a block diagram of a system for communicating content to information receivers, according to embodiments of the present invention;

FIG. 9 is a flow diagram of a method for communicating content to information receivers, according to embodiments of the present invention;

FIG. 10 is a flow diagram of an exemplary preferred reception mode selection process, according to embodiments of the present invention;

FIG. 11 shows an exemplary webpage for registering an information receiver, according to embodiments of the present invention; and

FIG. 12 is a flow diagram of an exemplary information receiver verification process, according to embodiments of the present invention.

### DETAILED DESCRIPTION OF THE PREFERRED EMBODIMENTS

In the following description of embodiments of the invention, reference is made to the accompanying drawings which form a part hereof, and in which is shown by way of illustration specific embodiments in which the invention may be practiced. It is to be understood that other embodiments may be utilized and structural changes may be made without departing from the scope of embodiments of the present invention.

Embodiments of the present invention describe a system and method by which an information broadcaster broadcasts content received from at least one information provider to a plurality of information receivers. A server device operated by the information broadcaster broadcasts the content over a network to client devices operated by information receivers. The content is transmitted to the client devices according to a preferred reception mode directly communicated from each of the client devices to the server device. The preferred reception mode may indicate a preferred content reception device for converting the content to a user perceptible form. The preferred content reception device may be selected from a facsimile machine, a facsimile printer and a processing device such as a computer or personal digital assistant. The preferred reception mode may further indicate that a client device is in a non-reception mode, i.e., no content should be sent to the client device.

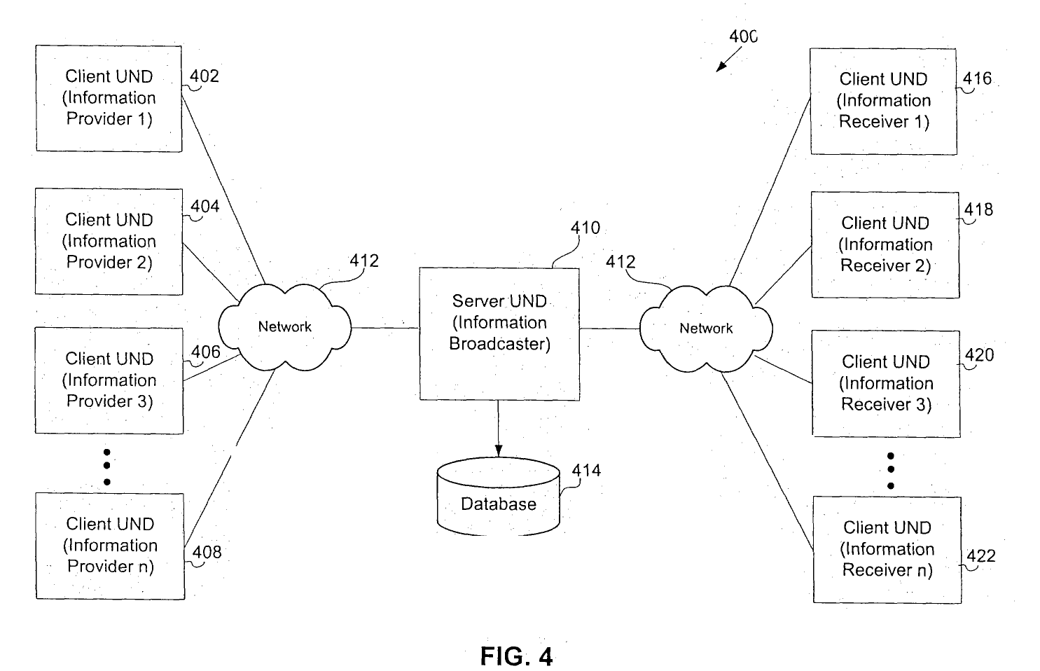

FIG. 4 is a block diagram of an exemplary client-server environment 400, such as the World Wide Web (the Web), in which a system and process according to embodiments of the invention may be employed. The architecture of the Web follows a conventional client-server model. The client device (also referred to as client User Network Device (“UND”)) and the server device (also referred to as server UND) communicate using a protocol such as HyperText Transfer Protocol (HTTP). In the Web environment, Web browsers reside on clients and render Web documents (pages) served by the Web servers. The client-server model is used to communicate information between the Client UNDs and the Server UND.

As shown in FIG. 4, server UND 410 is coupled to a network 412 and communicates with client UNDs 402, 404, 406 . . . 408, 416, 418, 420 . . . 422, which are also coupled to network 412. In a preferred embodiment, network 412 is the Internet. Other embodiments may employ other networks. According to embodiments of the present invention, coupling server UND 410 and client UNDs 402, 404, 406 . . . 408, 416, 418, 420 . . . 422 to the network 412 comprises providing wired or wireless transmission and reception of content between server UND 410 and client UNDs 402, 404, 406 . . . 408, 416, 418, 420 . . . 422 via network 412.

The coupling of server UND 410 and client UNDs 402, 404, 406 . . . 408, 416, 418, 420 . . . 422 to network 412 may be, for example, via a public telephone network (“PSTN”). The PSTN may include a local exchange carrier, an interexchange carrier, or a combination of local exchange carriers and interexchange carriers.

According to embodiments of the present invention, client UNDs 402, 404, 406 . . . 408 are UNDs of first, second, third and nth information providers (“information provider 1”, “information provider 2” “information provider 3” . . . “information provider n”), respectively. Client UNDs 416, 418, 420 . . . 422 are UNDs of first, second, third and nth information receivers (“information receiver 1”, “information receiver 2”, “information receiver 3” and “information receiver n”), respectively.

Client UNDs 402, 404, 406 . . . 408, 416, 418, 420 . . . 422 may be any user network device including, but not limited to, desktop and laptop computers, cellular phones, FAX machines, printers and personal digital assistants (“PDAs”). Client UNDs 402, 404, 406 . . . 408, 416, 418, 420 . . . 422 may include software, hardware, firmware or combinations thereof, for performing various functions including, but not limited to, sending, receiving, processing and displaying information (“content”).

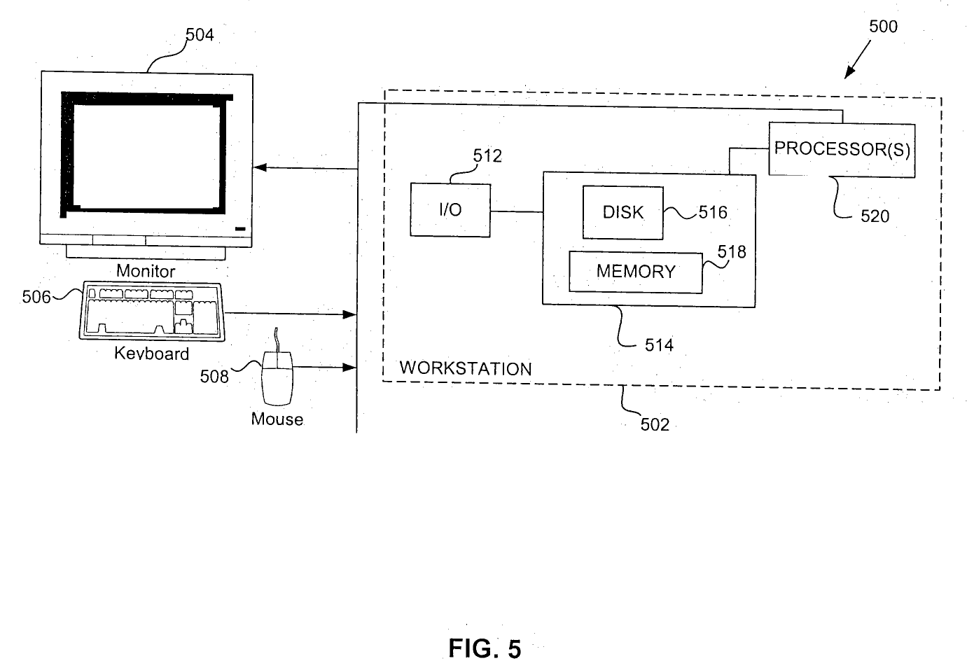

According to embodiments of the present invention, server UND 410 is a UND of an information broadcaster and may be any type of processing device or devices such as, but not limited to, desktop computers, work stations, laptops, and/or main frame computers. FIG. 5 illustrates an exemplary hardware/software environment 500 wherein embodiments of the system and process of the present invention may be employed. The system 500 may include a computer workstation 502, a computer monitor 504, and input devices such as a keyboard 506, and mouse 508. The workstation 502 may also include input/output interfaces 512, storage 514, such as a disk 516 and random access memory (RAM) 518, as well as one or more processors 520. The workstation 502 may be a computer workstation such as a Windows NT-type workstation or other suitable computer or computers. The computer monitor 504, keyboard 506, and mouse 508, as well as other input devices such as, but not limited to, scanners and hardware accelerators (not shown) may be used to interact with various software elements of the system residing in the memory of the workstation 502 to cause processes to be performed on data. The system 500 in FIG. 5 is shown by way of illustration and not limitation. Other systems may be used to implement embodiments of the invention.

Server UND 410 may comprise one or more servers such as, but not limited to, WEB servers, FAX servers, HyperText Transfer Protocol (“HTTP”) servers, File Transfer Protocol (“FTP”) servers, e-mail servers and file servers or a combination of two or more of such servers. Server UND 410 may include or be coupled to a database 414. Database 414 may be stored on a hard disk or other suitable memory device. Database 414 may, for example, include a list of information receivers (for example, the information providers' customers, subscribers and the like) provided to the information broadcaster by the information providers. Database 414 may also temporarily or permanently store content (i.e., information) to be provided to the information receivers. Database software employed, by the information broadcaster may maintain a correspondence between particular information receivers and particular content to be communicated to the particular information receivers. According to embodiments of the present invention, database 414 may be implemented using any suitable database software.

Server UND 410 may also be coupled to a local display device (not shown) for displaying information. For example, when exemplary client-server environment 400 is the Web, the local display device may display information to website administrators for purposes including, but not limited to, programming, managing, testing, and maintaining the website.

According to embodiments of the present invention, exemplary client-server environment 400 is adapted such that server UND 410 (operated by the information broadcaster) may receive lists of information receivers and content that are communicated from UNDs 402, 404, 406 . . . 408 (operated by information providers 1, 2, 3 . . . n). As an example, information providers 1, 2, 3 . . . n may be mortgage lenders such as wholesale mortgage companies and banking institutions. Information receivers 1, 2, 3 . . . n may be, for example, retail mortgage brokers. According to an exemplary embodiment of the present invention, a mortgage lender may provide mortgage rate information and a database file of retail mortgage brokers to the information broadcaster. The information broadcaster will, in turn, broadcast the provided mortgage rate information to the listed retail mortgage brokers (for example, by fax or e-mail).

According to a preferred embodiment of the present invention, the information broadcaster maintains a website. Information providers 1, 2, 3 . . . n may establish communication between their client UNDs 402, 404, 406 . . . 408 and the server UND 410 via network 412. While the actual sequence of events and operation may vary with different embodiments, in one example embodiment a client UND of an information provider first connects to the website using a web-browser, such as Netscape Navigator or Internet Explorer. The information provider may then log into the website, for example with a user identifier and password.

During the login process, the website may derive information about the user's UND to provide proper support for the user's interaction (for example, to determine the optimum bandwidth to use). Once logged into the website of the information broadcaster, the information providers 1, 2, 3 . . . n may then upload content and lists of information receivers to the server UND 410.

According to embodiments of the present invention, the information providers 1, 2, 3 . . . n may provide content (for example, a document) to the information broadcaster by, for example, uploading the content in a particular format to the server UND 410. According to one embodiment, a user interface, for example a webpage, may be provided by the information broadcaster that enables the information providers to upload content in various user-selectable formats.

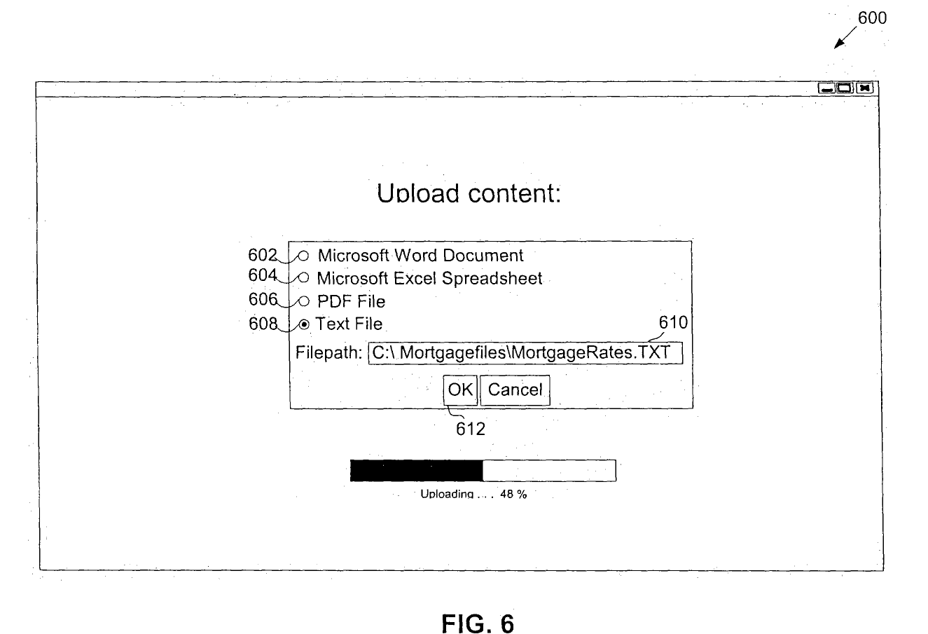

FIG. 6 shows an exemplary webpage 600 for uploading content, according to embodiments of the present invention. The information provider may select a particular format of the content (for example, a Microsoft Word document, a Microsoft Excel spreadsheet, an Adobe Portable Document Format (PDF) document, text file and the like) to be uploaded by selecting a user-selectable operator such as radio buttons 602, 604, 606 and 608, entering a filepath for the content in textbox 610 and selecting the “OK” user-selectable operator 612. According to alternative embodiments of the present invention, the server UND 410 may be adapted to automatically detect a particular format of uploaded content. In that case, the information provider may only designate a filepath of the content to be uploaded.

According to embodiments of the present invention, the server UND 410 may then display the uploaded content to the information provider on a display screen (not shown) associated with the information provider's respective client UND so that the information provider may verify the accuracy, format, etc. of the content. Once verified by the information provider, the content may be temporarily or permanently stored by the information broadcaster, for example, in database 414 (FIG. 4).

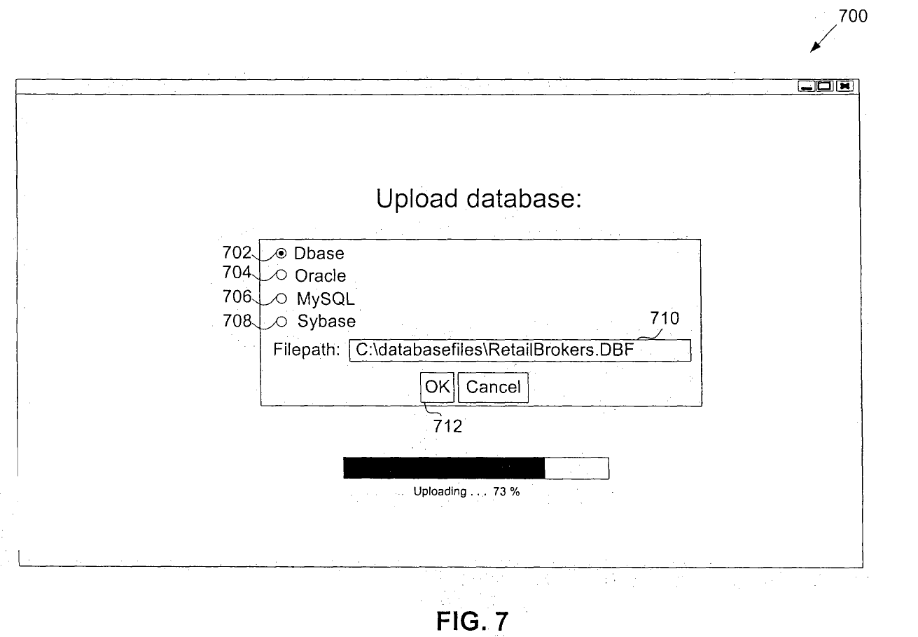

According to embodiments of the present invention, information providers 1, 2, 3 . . . n may also upload a listing of information receivers to the information broadcaster, for example in the form of a database file or files. According to one embodiment, a user interface, for example a webpage, may be provided by the information broadcaster that enables the information providers to upload a database file or files in various user-selectable formats. FIG. 7 shows an exemplary webpage 700 for uploading a database file, according to embodiments of the present invention. The information provider may select a particular database file format of the database file (for example, dBase, Oracle, MySQL, Sybase, and the like) to be uploaded by selecting a user-selectable operator such as radio buttons 702, 704, 706 and 708, entering a filepath for the database file in textbox 710 and selecting the “OK” user-selectable operator 712. The uploaded database file may then may be stored, for example in database 414.

According to alternative embodiments of the present invention, the server UND 410 may be adapted to automatically detect a particular database file format. In that case, the information provider may only designate a filepath of the database file to be uploaded.

According to embodiments of the present invention, the uploaded database file may be temporarily or permanently stored by the information broadcaster, for example, in database 414. The uploaded database file may include information about the information receivers including, but not limited to, fax numbers, telephone numbers, company names, first names and last names of individuals, street addresses of companies and/or individuals, e-mail addresses and account numbers.

According to embodiments of the present invention, the information broadcaster may provide to the information providers 1, 2, 3 . . . n a database application to be run on the information provider's respective client UND. The database application may be provided to the information provider, for example, by mailing to the information provider a computer readable medium having the database application recorded thereon. Alternatively, the information provider may be able to download the database application from the information broadcaster's website.

The database application may interface with the website and/or server and may enable the information provider to load data into the database application (for example information about information receivers) from files (for example, Microsoft Excel files) located on the information provider's client UND. The information provider may then be able to manage the data by, for example, building groups, sorting by data fields, performing keyword searches and the like. The data may then be uploaded to the website and/or server as a database file.

A printer application may further manage the content by, for example, formatting documents (for example, as Tag Image File Format (TIFF) files) to be uploaded to the website. The printer application may query the information provider to select a group of information receivers managed by the printer application to which the content should be sent. The printer application may also query the information receiver about a time at which the content should be sent.

According to other embodiments, the content and/or listing of information receivers may, in the alternative, be conventionally mailed or otherwise communicated by the information providers to the information broadcaster as a hardcopy. The hardcopy may then be manually converted to an electronic format and stored by the information broadcaster.

Referring again to FIG. 4, according to embodiments of the present invention, exemplary client-server environment 400 is further adapted such that server UND 410 may communicate the content to UNDs 416, 418, 420 . . . 422 (operated by information receivers 1, 2, 3 . . . n included on the lists).

According to embodiments of the present invention, information receivers operating UNDs 416, 418, 420 . . . 422 may select a preferred mode for receiving the content. The preferred reception mode may include the selection of a preferred content reception device, i.e., a preferred device for receiving the content and converting the content to a user perceptible form, for example to a printed document, to content viewable on a computer monitor, and the like. According to embodiments of the present invention, the preferred content reception devices may include, but are not limited to a fax machine, a fax printer and a processing device (for example, reception by an e-mail or fax application running on the processing device).

However, in contrast to the conventional method of preferred reception mode selection discussed above, embodiments of the present invention enable information receivers to provide their preferred reception mode selections directly to the information broadcaster. This advantageously reduces the burden on the information providers resulting from receiving the preferred reception mode selections from the information receivers and communicating them to the information broadcaster.

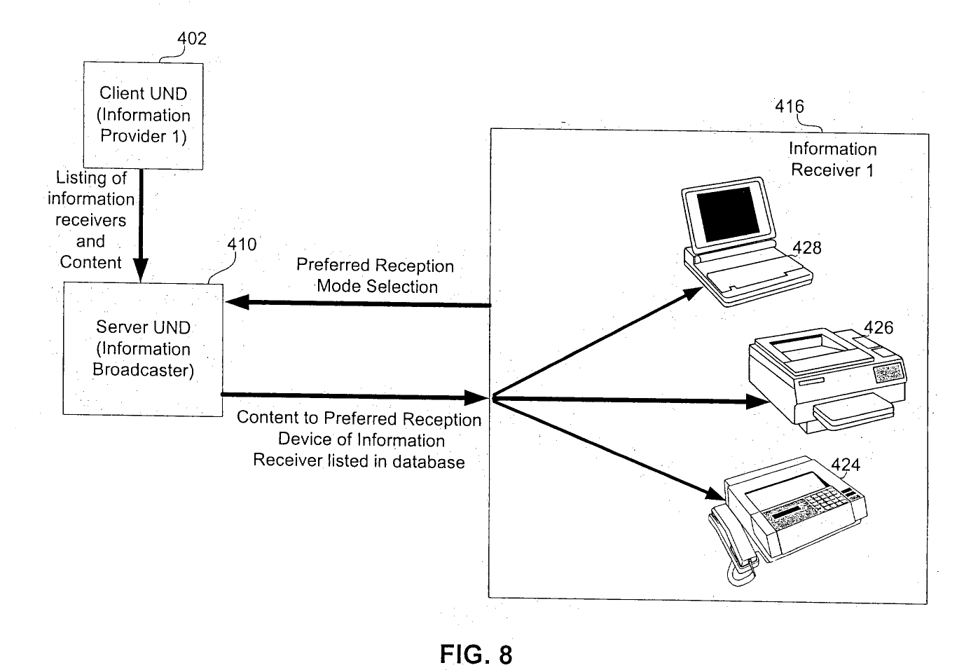

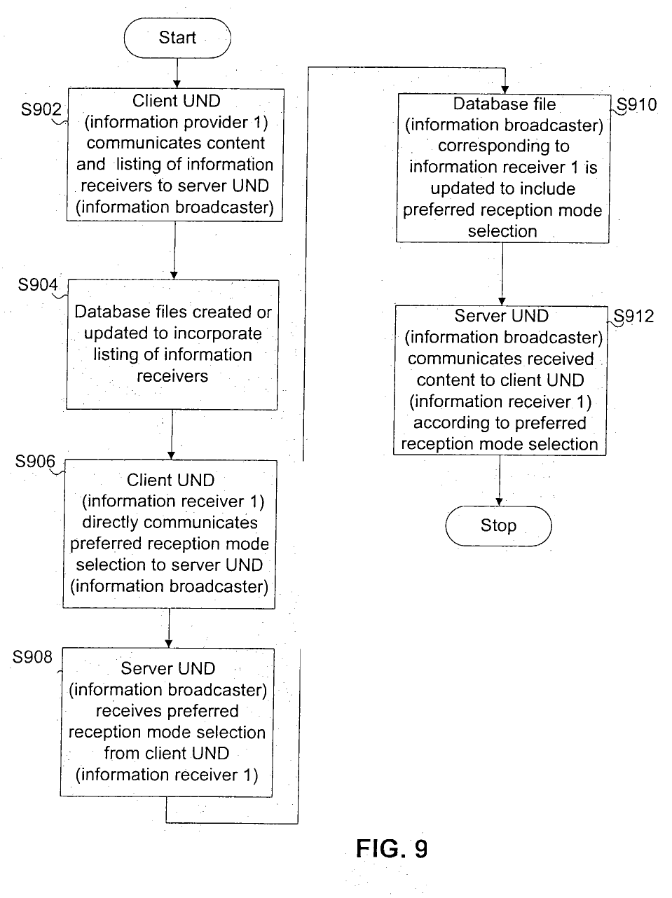

FIGS. 8 and 9 show a block diagram and a flow diagram of a system and method, respectively, for communicating content to information receivers, according to embodiments of the present invention. As shown, client UND 402 (information provider 1) communicates content and a listing of information receivers (for example, a database file) to server UND 410 (S902). In the present example, it is assumed that information receiver 1 is included in the listing of information receivers communicated by client UND 402. Database 414 (FIG. 4) may then be updated to incorporate the listing of information receivers and the content (S904).

As shown in FIGS. 8 and 9, client UND 416 (information receiver 1) directly communicates the preferred reception mode selection to server UND 410 (information broadcaster) rather than to the client UND 402 (S906). As stated above, the preferred reception mode may designate a preferred content reception device. As shown in FIG. 8, in the present example, the exemplary preferred content reception device may be selected from among a fax machine 424, a fax printer 426 and a computer 428 (i.e., reception by e-mail or fax application running on computer 428). According to other embodiments, other preferred content reception devices may be selected including, but not limited to, cellular phones, PDAs and any other suitable device for receiving information over a network.

According to embodiments of the present invention, server UND 410 receives the preferred reception mode selection from client UND 416 (S908) and a database file in database 414 corresponding to information receiver 1 may be updated to include the preferred reception mode selection (S910). For example, a preferred reception mode field in the database file corresponding to information receiver 1 may be updated to indicate the preferred content reception device.

When content is directed to information receiver 1, the preferred reception mode field in the database file corresponding to information receiver 1 may be checked. Server UND 410 (information broadcaster) then communicates the received content to client UND 416 (information receiver 1) according to the preferred reception mode field in the database file corresponding to information receiver 1 (S912).

According to embodiments of the present invention, the information broadcaster may communicate the received content to the information receiver as soon as the information broadcaster receives it from the information provider, or sometime thereafter. According to other embodiments, information broadcaster may await a communication from the information receiver authorizing that the content be sent to the information receiver. The request may be communicated to the information broadcaster, for example, via telephone (not shown) or network 412 (FIG. 4).

Thus, according to embodiments of the present invention, if the information receiver 1 desires to change its preferred reception mode, the information receiver 1 may directly communicate a selection of a new preferred reception mode directly to the information broadcaster. The information broadcaster may then update information in a database such that content will be directed to the information receiver 1 according to the selected preferred reception mode. Thus, it is not necessary for the information provider 1 to be involved in the preferred reception mode selection process. This may reduce the burden on the information provider 1 when, for example, there is a large number of information receivers and/or the information receivers frequently change their preferred reception mode.

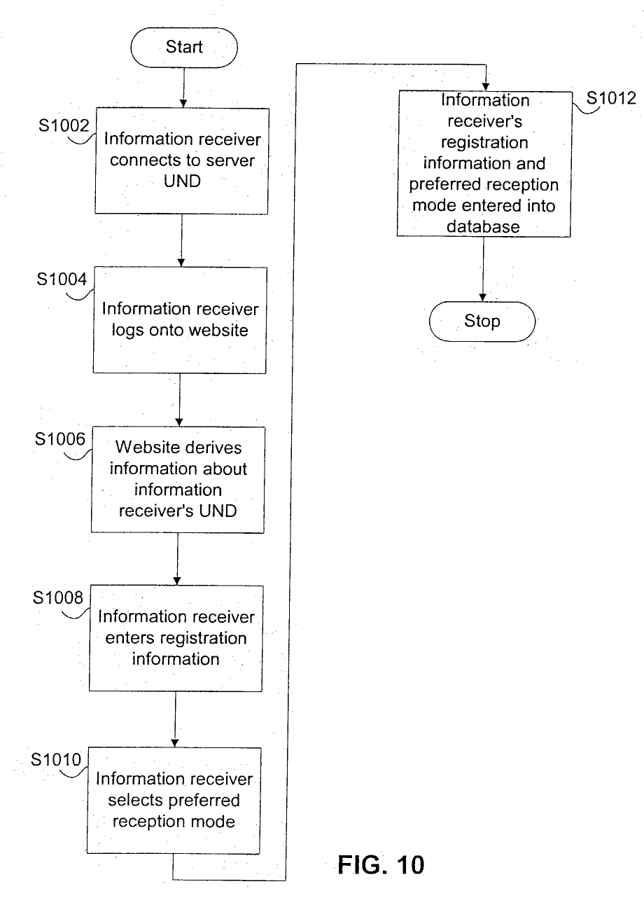

FIG. 10 shows a flow diagram of an exemplary preferred reception mode selection process, according to embodiments of the present invention. While the actual sequence of events and operation of the client UNDs and server UND may vary with different embodiments, in one example embodiment a client UND of an information receiver first connects to the server UND 410 (FIG. 4) using, for example, a web-browser, such as Netscape Navigator or Internet Explorer (S1002). The information receiver may then log into a website maintained by the information broadcaster, with, for example, a user identifier and password (S1004). A new information receiver may also register with the website to establish a user identifier and password.

During the login process and registration, the website may derive information about the information receiver's UND to provide proper support for the information receiver's interaction (for example, to determine the optimum bandwidth to use) (S1006). Once the log in is complete, an information receiver new to the website may first register with the information broadcaster. During the registration process, the information receiver may be prompted to enter certain registration information onto the webpage (S1008). This information may include, but is not limited to, a fax number of the information receiver, a voice number of the information receiver, first and last names of the information receiver, an e-mail address of the information receiver, and a password.

According to embodiments of the present invention, the information receiver may also be prompted to select a preferred reception mode (S1010). The preferred reception mode may be selected by the information receiver during the registration process. In this case, the webpage on which the information receiver registers may enable the information receiver to select a preferred reception mode. According to alternative embodiments, however, the preferred reception mode selection may be performed independently of the registration process, for example, on a separate webpage maintained by the information broadcaster.

According to embodiments of the present invention, the preferred reception mode may be selected such that content received from all information providers via the information broadcaster is directed to a preferred content reception device. In the alternative, the information receiver may select that content received from particular information providers be directed to a particular preferred content reception device, while content received from other information providers be directed to one or more other preferred content reception devices.

As an example, referring again to FIGS. 4 and 8, information receiver 1 (client UND 416) may specify that content received from all information providers (information providers 1, 2, 3 . . . n) be directed to fax machine 424. As another example, information receiver 1 may alternatively specify that content received from information provider 1 (client UND 402) be directed to fax machine 424, while content received from other information providers (information providers 2, 3 . . . n) be directed to computer 428 (i.e., reception by e-mail, or fax application running on computer 428). According to a further example embodiment, the information receiver 1 may alternatively specify that content received from information provider 1 (client UND 402) be directed to fax machine 424. The information receiver 1 may further specify that content received from information provider 2 (client UND 404) be directed to fax printer 426, while content received from the remaining information providers (information providers 3 . . . n) (client UNDs 406 . . . 408) be directed to computer 428 (i.e., reception by e-mail or fax application running on computer 428).

Referring again to FIG. 10, after the information receiver enters the requested information and selects a preferred reception mode, the information broadcaster may then send an e-mail confirmation to the information receiver and request a response from the information receiver. The e-mail response from the information receiver may be used to confirm the validity of the information receiver's e-mail address. After confirmation of the response, the information receiver's registration information and preferred reception mode may be entered into a database (S1012).

According to embodiments of the present invention, as part of the registration process the information broadcaster may request that the information receiver communicate with the information broadcaster using the information receiver's fax machine and/or telephone (voice) such that an Automatic Number Identification (ANI) of the information receiver's fax machine and/or telephone may be detected and registered. The ANI may be used for security purposes.

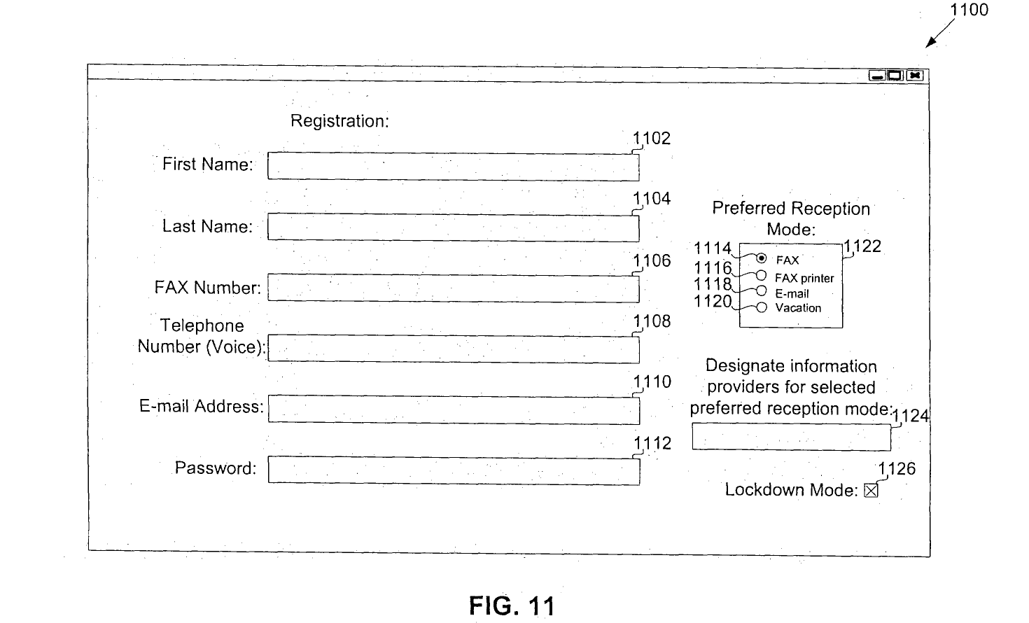

FIG. 11 shows an exemplary webpage 1100 for registering an information receiver, according to embodiments of the present invention. Exemplary webpage 1100 may be maintained by the information broadcaster. As shown in FIG. 11, exemplary webpage 1100 includes textboxes 1102, 1104, 1106, 1108, 1110 and 1112 for entering an information receiver's registration information. According to embodiments of the present invention shown in FIG. 11, the registration information includes first name, last name, fax number, telephone number (voice), e-mail address and password. Alternative embodiments of the present invention may include only some of textboxes 1102, 1104, 1106, 1108, 1110 and 1112 or may include different or additional textboxes for entering different or additional registration information.

As shown in FIG. 11, webpage 1100 enables the information receiver to select a preferred reception mode by providing user-selectable operators such as radio buttons 1114, 1116 and 1118 for selecting, respectively, an information receiver's fax machine, fax printer or e-mail application (running, for example, on an information receiver's desktop computer, laptop computer, PDA or other suitable processing device) as a preferred device for receiving content from an information provider. Fax printer refers to a process wherein a printer coupled to a computer or other processing device is controlled by the computer to print received content. According to an embodiment of the present invention, a software application runs on the computer and programs the computer to receive the content from the information broadcaster and to automatically print the received content on the fax printer.

According to some embodiments of the present invention, the information receiver may also be able to designate a particular information provider or information providers to which the selected preferred reception mode is applicable by, for example, entering an identification (for example, a name, account number, or other identifier) of the information provider into textbox 1124.

According to embodiments of the present invention, an information receiver may further select as a preferred reception mode a “vacation mode” (i.e., a non-reception mode). Selecting the vacation mode enables the information receiver to notify the information broadcaster that no content should be sent to the information receiver. As an example, the information receiver may select the vacation mode when going out of town. This may be done in order that the information receiver avoids returning to, for example, a large number of printed faxes or e-mail messages containing time sensitive content provided by information providers while the information receiver is away.

The time sensitive content may have no value by the time the information receiver returns. Thus, by selecting the vacation mode, the information receiver may advantageously avoid accumulation of useless information. In addition, the information providers may advantageously avoid the costs involved in sending content to an absent or uninterested information receiver. For example, the information broadcaster will not send the content to an absent or uninterested information receiver who has designated their client device as being in a non-reception mode. In turn, the information broadcaster may then only charge the information provider for content that was sent to client devices that have nor been so designated. Thus, the fees paid by the information provider to the information broadcaster may be reduced. The vacation mode may be selected, for example, by selecting a user-selectable operator such as radio button 1120.

According to embodiments of the present invention, an information receiver may further select a “lockdown mode”, for example, by selecting a user-selectable operator such as checkbox 1126. When the lockdown mode is not selected, the information receiver may log into the website and may change the registration information by providing the registered password. The information receiver may also change the preferred reception mode. On the other hand, if the lockdown mode is selected by an information receiver, this prevents anyone, including the information receiver, from being able to change any of the information provided by the information receiver (including the preferred reception mode). Access may be denied, for example, by denying access to the registration webpage (and/or the preferred reception mode selection webpage) unless a certain information receiver verification process is executed.

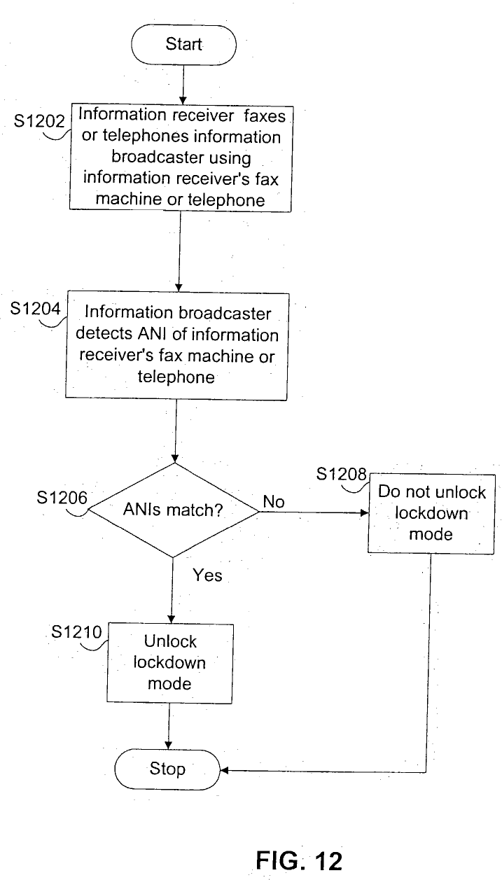

FIG. 12 shows a flow diagram of an exemplary information receiver verification process; according to embodiments of the present invention. As shown in FIG. 12, when the lockdown mode has previously been set by an information receiver, the information receiver may “unlock” the lockdown mode by faxing or telephoning the information broadcaster from the information receiver's fax machine or telephone (voice) (S1202). The information broadcaster may then detect the ANI of the information receiver's fax machine or telephone (S1204). It is assumed here that the ANI of the information receiver's fax machine or telephone has been previously detected and/or registered, for example as part of the registration process described above.

It may then be determined by the information broadcaster if the detected ANI matches the information receiver's previously registered ANI, telephone number and/or fax number (S1206). If the detected ANI does not match the information receiver's registered ANI, telephone number and/or fax number (No), then the lockdown mode is not unlocked (S1208). If, however, the detected ANI does match the information receiver's registered ANI, telephone number and/or fax number (Yes), then the lockdown mode is unlocked (S1210). When the lockdown mode is unlocked, the information receiver may again access and edit the information receiver's registration information, including changing the preferred reception mode by, for example, selecting a different preferred content reception device.

Embodiments described herein may be employed to broadcast or otherwise communicate various types of information to information receivers and may be applicable in a variety of information communication contexts. Examples described above include mortgage rate and broker information. In other contexts, other types of information may be communicated, including, but not limited to price quotes for stocks or other securities or tradable commodities, inventory information, weather or climate information, advertisements, limited time offers and the like.

Recent regulations have been adopted by the FCC relating to the broadcast or communication of advertisements by fax (for example, the Telephone Consumer Protection Act of 1991 and the FCC Order (FCC-03-153) released Jul. 3, 2003). In general, such regulations may require the sender of unsolicited advertisements to have obtained prior consent, signed by the receiver before an advertisement may be sent to the receiver. Embodiments of the present invention may further include a mechanism and process by which such prior consent may be obtained, recorded and managed.

According to such embodiments, during or after registration of an information receiver on the website described above, a form consent letter or agreement may be electronically generated and displayed to the information receiver. The consent letter or agreement may be generated, automatically, by software running on the website server, based on the registration information provided by the information receiver. Thus, if an information receiver registers for receiving content from a particular information provider, a consent letter or agreement authorizing that information provider to send advertisement or special offer information by fax to the information receiver. The information provider may be prompted to review and sign (electronically) the displayed consent letter or agreement, for example by inserting signature text or clicking (with a mouse) on a designated signature location on the displayed letter or agreement. The signed consent letter may be displayed and provided in a printable form to the information receiver. In addition, a copy of the signed consent letter may be forwarded to the particular information provider identified in the letter or agreement. An electronic copy of the signed consent letter may be stored in the database associated with the server, for future reference.

The server UND and/or each client UND may maintain a record of the consents given for each information provider. In this regard, the broadcasting or selective communication of advertisement information from any given information provider may be controlled to be received by only those information receivers for which a record of consent specific to the given information provider has been recorded.

While the consent letter or agreement may be offered to the information receiver at the time of registration, in other embodiments, the information receiver may receive an invitation communication (by email, fax, telephone, mail or the like) after registration had been completed. The invitation may instruct the information receiver to access a particular website page to register a consent letter or agreement. Upon accessing the particular website page, the information receiver may be prompted to provide information or otherwise complete and sign (electronically) a consent letter or agreement, as described above.

System and device functions and processes described herein may be implemented with machine-executable instructions. Software comprising these instructions may be used to program and cause general-purpose or special-purpose processors to perform the functions and processes described herein. Alternatively, such functions and processes may be implemented by firmware, hardware comprising hardwired logic, or by any combination thereof.

These and other features and advantages of embodiments of the invention will be apparent to those skilled in the art from the foregoing detailed description of embodiments of the invention, when read with the drawings and appended claims. It is to be understood that even though numerous characteristics and advantages of embodiments of the present invention have been set forth in the foregoing description, together with details of the structure and function of embodiments of the invention, this disclosure is illustrative only. Changes may be made in detail, especially matters of structure and management of parts within the principles of the present invention to the full extent indicated by the broad general meaning of the terms in which the appended claims are expressed.

Having disclosed exemplary embodiments and the best mode, modifications and variations may be made to the disclosed embodiments while remaining within the scope of the invention as defined by the following claims.

1. A system with at least one server device and a plurality of client devices communicating content to and from the at least one server device via a network, the system comprising a processor programmed for receiving content from at least one of the plurality of client devices and transmitting the content to at least one other of the client devices according to a preferred reception mode directly communicated from the at least one other of the client devices to the at least one server device.

2. The system recited in claim 1, wherein the at least one other of the client devices comprises a plurality of other client devices and wherein the content is broadcasted by the at least one server device to the plurality of other client devices.

3. The system recited in claim 2, wherein the content is broadcasted by facsimile to the plurality of other client devices.

4. The system recited in claim 2, wherein the content is broadcasted by electronic mail to the plurality of other client devices.

5. The system recited in claim 1, wherein the preferred reception mode comprises at least one of receiving the content by facsimile and receiving the content by electronic mail.

6. The system recited in claim 5, wherein receiving the content by electronic mail further comprises automatically printing the received content.

7. The system recited in claim 1, wherein the preferred reception mode indicates a preferred content reception device associated with the at least one other of the client devices, the preferred content reception device for converting the content to a user perceptible form.

8. The system recited in claim 7, wherein the preferred content reception device is at least one of a facsimile machine, a facsimile printer, and a processing device.

9. The system recited in claim 8, wherein the processing device runs at least one of a facsimile application for receiving the content and an electronic mail application for receiving the content.

10. The system recited in claim 7, wherein the preferred reception mode further indicates at least one content provider designated to provide the content to the at least one other of the client devices.

11. The system recited in claim 7, wherein the preferred reception mode further indicates that the content should not be provided to the at least one other of the client devices.

12. The system recited in claim 1, wherein the processor is further programmed for implementing a lockdown mode wherein the preferred reception mode communicated from the at least one other of the client devices can only be altered after an information receiver verification process.

13. The system recited in claim 12, wherein the information receiver verification process comprises verifying an Automatic Number Identification (ANI) associated with the at least one other of the client devices.

14. A system for selecting a preferred mode for receiving content, the system comprising:
at least one first client device adapted for transmitting content;
at least one second client device adapted for receiving the content; and
at least one server device adapted for receiving the content transmitted from the at least one first client device and re-transmitting the content to the at least one second client device according to a preferred reception mode directly communicated from the at least one second client device to the at least one server device.

15. The system recited in claim 14, wherein the preferred reception mode indicates a preferred content reception device for converting the content to a user perceptible form.

16. The system recited in claim 15, wherein the preferred content reception device is coupled to the at least one second client device.

17. The system recited in claim 15, wherein the preferred content reception device is at least one of a facsimile machine, a facsimile printer, and a processing device.

18. The system recited in claim 17, wherein the processing device runs at least one of a facsimile application for receiving the content and an electronic mail application for receiving the content.

19. The system recited in claim 14:
wherein the at least one second client device comprises a plurality of second client devices adapted to receive content; and
wherein the at least one server device broadcasts the content received from the at least one first client device to the plurality of second client devices according to a preferred reception mode communicated directly to the at least one server device by each of the plurality of second client devices.

20. The system recited in claim 14, wherein the at least one first client device is adapted for transmitting content over a network.

21. The system recited in claim 20, wherein the network is the Internet.

22. The system recited in claim 14, wherein the at least one second client device is adapted for receiving content over a network.

23. The system recited in claim 22, wherein the network is the Internet.

24. The system recited in claim 14, wherein the at least one server device is adapted for providing a webpage for accepting the content from the at least one first client device.

25. The system recited in claim 14, wherein the content comprises a formatted document.

26. The system recited in claim 14, wherein the at least one server device is adapted for receiving a listing of information associated with a plurality of second client devices adapted for receiving the content according to a preferred reception mode directly communicated from the at least one second client device to the at least one server device.

27. The system recited in claim 26, wherein the listing is a database file.

28. The system recited in claim 26, wherein the information comprises at least one of a first name, a last name, a facsimile number, a telephone number and an electronic mail address.

29. The system recited in claim 26, wherein the at least one server device is adapted for providing a webpage for accepting the listing.

30. A system for selecting a preferred device for receiving content, the system comprising:
at least one first client device adapted for transmitting content;
at least one second client device associated with a plurality of content reception devices; and
at least one server device adapted for receiving the content transmitted from the at least one first client device and re-transmitting the content to the at least one second client device according to a preferred content reception device selection directly communicated from the at least one second client device to the at least one server device such that at least one selected content reception device converts the content to a user perceptible form.

31. The system recited in claim 30, wherein at least one of the plurality of content reception devices is coupled to the at least one second client device.

32. The system recited in claim 31, wherein the plurality of content reception devices comprise at least one of a facsimile machine, a facsimile printer, and a processing device.

33. The system recited in claim 32, wherein the processing device runs at least one of a facsimile application for receiving the content and an electronic mail application for receiving the content.

34. A method for selecting a preferred mode for receiving content, the method comprising:
providing at least one server device for communicating content to and from a plurality of client devices;
receiving content from at least one content provider; and
transmitting the content to at least one of the client devices according to a preferred reception mode directly communicated from the at least one of the client devices to the at least one server device.

35. The method recited in claim 34, wherein the at least one of the client devices comprises a plurality of client devices and wherein the content is broadcasted by the at least one server device to the plurality of client devices.

36. The method recited in claim 35, wherein the content is broadcasted by facsimile to the plurality of client devices.

37. The method recited in claim 35, wherein the content is broadcasted by electronic mail to the plurality of client devices.

38. The method recited in claim 34, wherein the preferred reception mode comprises at least one of receiving the content by facsimile and receiving the content by electronic mail.

39. The method recited in claim 34, wherein the preferred reception mode indicates a preferred content reception device associated with the at least one of the client devices, the preferred content reception device for converting the content to a user perceptible form.

40. A method for providing to an information receiver content received from information providers, the method comprising:
providing at least one server device for receiving the content from the information providers and for transmitting the content to at least one first client device associated with the information receiver; and
providing a user interface accessible to the at least one first client device, the user interface including user-selectable operators for enabling the information receiver to select a preferred reception mode, the preferred reception mode indicating a preferred content reception device associated with the at least one first client device, the preferred content reception device for converting the content to a user perceptible form.

41. The method recited in claim 40, wherein providing at least one server device for receiving the content from the information providers comprises programming the at least one server device for receiving the content from at least one second client device in communication with the at least one server device, the at least one second client device being associated with the information providers.

42. The method recited in claim 40, wherein providing a user interface accessible to the at least one first client device comprises providing a webpage accessible to the at least one first client device over the Internet.

43. The method recited in claim 40, wherein the user interface enables the information receiver to select the preferred reception mode during a process for registering the information receiver.

44. The method recited in claim 40, wherein the user interface enables the information providers to upload the content to the at least one server device.

45. The method recited in claim 40, wherein the user interface enables the information providers to upload a listing of information receivers to the at least one server device.

46. A billing method for an information broadcaster, the information broadcaster broadcasting, for a fee, to a plurality of client devices associated with a corresponding plurality of information receivers content received from information providers, the method comprising:
providing a user interface accessible to the information receivers, the user interface enabling an information receiver to specify that a client device associated with the information receiver be in a non-reception mode;
broadcasting the content only to ones of the plurality of client devices that are not in a non-reception mode; and
receiving a fee from the information providers that is proportionate to a number of client devices to which the content was broadcasted.

47. A method for securely identifying an individual, comprising:
receiving identification information of a first individual during a first communication session, wherein the identified individual has a first communication device having an Automatic Number Identification (ANI);
verifying, during a second communication session, that an unknown individual claiming to be the first individual is the actual first individual by detecting an Automatic Number Identification (ANI) of an unknown communication device used by the unknown individual during the second communication session and associating and comparing the detected Automatic Number Identification (ANI) with identification information received during the first communication session.

48. The method recited in claim 47, further comprising storing the received identification information of the first individual and the Automatic Number Identification (ANI) of the first communication device in association with one another.

49. The method recited in claim 47, wherein the first communication device is a facsimile machine.

50. The method recited in claim 47, wherein the first communication device is a telephones.

51. The method recited in claim 47, wherein the ANI of the first communication device corresponds to a telephone line number on which a facsimile machine is connected.

52. The method recited in claim 47, the ANI of the first communication device corresponds to a telephone line number on which a telephone is connected.

53. A method for communicating information to an information receiver's computer system, comprising:
receiving registration information for an information receiver, the registration information including a telephone number for a facsimile machine accessible by the information receiver;
providing displayable content through a network to the information receiver for displaying a consent letter or agreement on the information receiver's computer system;
receiving, through the network, an indication of consent from the information receiver; and
controlling further facsimile communications to the information receiver, based on the indication of consent received from the information receiver.

54. The method recited in claim 53, wherein the registration information comprises identification information that identifies at least one information provider and wherein the consent letter or agreement specifies that the information receiver consents to receiving information from the at least one identified information provider.

55. The method recited in claim 54, wherein controlling further facsimile communications comprises avoiding sending an information provider's advertisement communications by facsimile transmission to the information receiver unless an indication of consent has been received from the information receiver for the information provider.

56. The method recited in claim 53, wherein receiving an indication of consent comprises receiving an electronic signature for the consent letter or agreement.
